(19) United States
(12) Patent Application Publication
(10) Pub. No.: US 2017/0204662 A1
(43) Pub. Date: Jul. 20, 2017

(54) Safety Step Stepladder

(71) Applicant: Bradley Phillip Perdue, Holly Hill, FL (US)

(72) Inventor: Bradley Phillip Perdue, Holly Hill, FL (US)

(21) Appl. No.: 15/403,913

(22) Filed: Jan. 11, 2017

Related U.S. Application Data
(60) Provisional application No. 62/279,116, filed on Jan. 15, 2016.

(51) Int. Cl. E06C 1/20; E06C 7/46

(52) U.S. Cl. CPC E06C 1/20; E06C 7/46

(57) ABSTRACT

A ladder with supplementary support legs is an apparatus that provides increased stability when compared to traditional stepladders. The apparatus includes a left support mechanism, a right support mechanism, and a front set of rungs. The left support mechanism and the right support mechanism are identical halves of the apparatus. Each support mechanism includes a ladder rail, a bracing leg, and a pivoting outrigger. The ladder rail and bracing leg are hinged together and are able to move between an expanded and collapsed configuration. The outrigger pivots away from the ladder rail and bracing leg to create a tripod between the three legs. The front set of rungs functions as steps which are connected between the ladder rails of the left support mechanism and the right support mechanism.

The current application claims a priority to the U.S. Provisional Patent application Ser. No. 62/279,116 filed on Jan. 15, 2016.

### FIELD OF THE INVENTION

The present invention relates generally to step ladders. More specifically, the present invention relates to an A-frame ladder with a first support leg and a second support leg which fold outwards to provide enhanced stability, as well as prevent unwanted sliding, shifting, and tipping of the device.

### BACKGROUND OF THE INVENTION

Ladders are an inclined set of rungs or steps used to assist individuals with reaching elevated points. These devices are often portable, with many types of configuration variations existing. Some examples of ladders include but are not limited to attic ladders, folding ladders, fixed ladders, step ladders, twin stepladders, and more. Such devices are generally made out of sturdy and lightweight metals, however, other materials may be used depending on the structural configuration and use. While quite useful, there exists many problems with ladder safety, as these devices are prone to tipping, slipping, and sliding.

It is therefore an objective of the present invention to introduce a safety step stepladder. The present invention utilizes a twin stepladder configuration, with the addition of outrigger support legs. These outriggers fold outwards to provide enhanced stability, as well as prevent unwanted sliding, shifting, and tipping of the device. The present invention improves upon existing ladders and provides increased safety. Thus, lowering the risk of damage to people or property. Overall, the present invention is sturdy, lightweight, easy to use, safe, and effective.

### BRIEF DESCRIPTION OF THE DRAWINGS

FIG. 1 is a perspective view of the present invention.

FIG. 2 is a top view of the present invention.

FIG. 3 is a front perspective view of the left support mechanism used in the present invention.

FIG. 4 is a rear perspective view of the left support mechanism used in the present invention.

FIG. 5 is a detailed view of present invention taken about the circle 5 in FIG. 3.

FIG. 6 is a detailed view of present invention taken about the circle 6 in FIG. 3.

FIG. 7 is a detailed view of present invention taken about the circle 7 in FIG. 4.

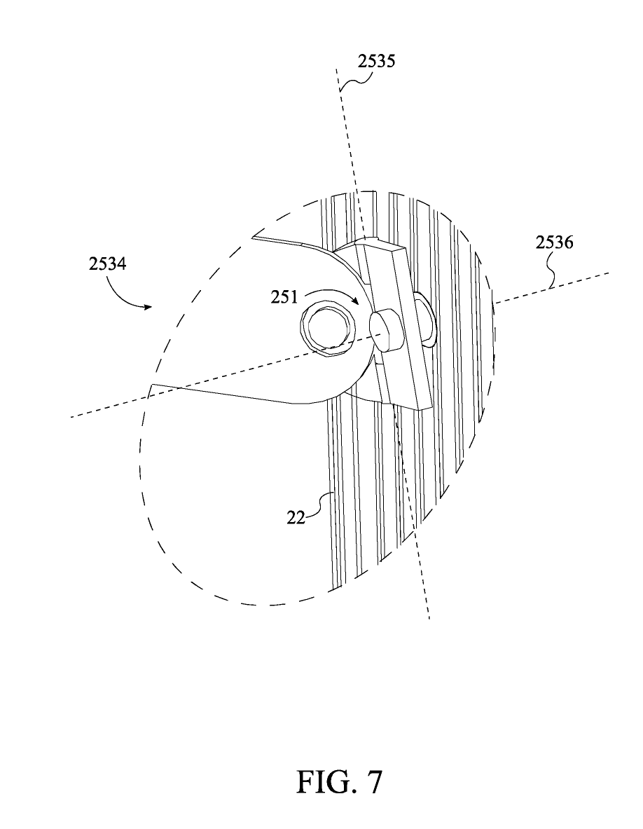

FIG. 8 is a detailed view of present invention taken about the circle 8 in FIG. 4.

### DETAIL DESCRIPTIONS OF THE INVENTION

All illustrations of the drawings are for the purpose of describing selected versions of the present invention and are not intended to limit the scope of the present invention.

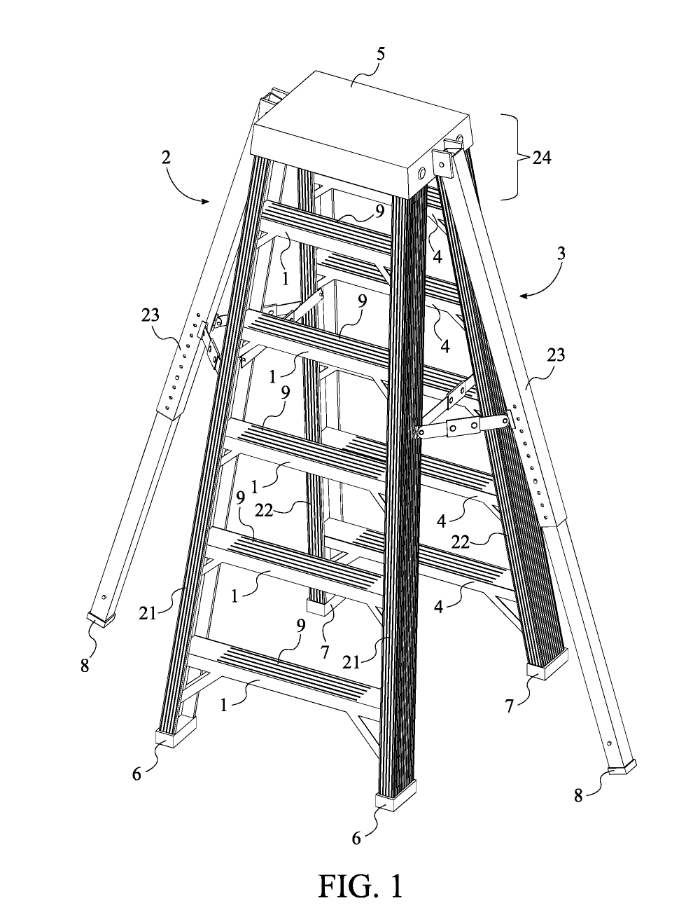

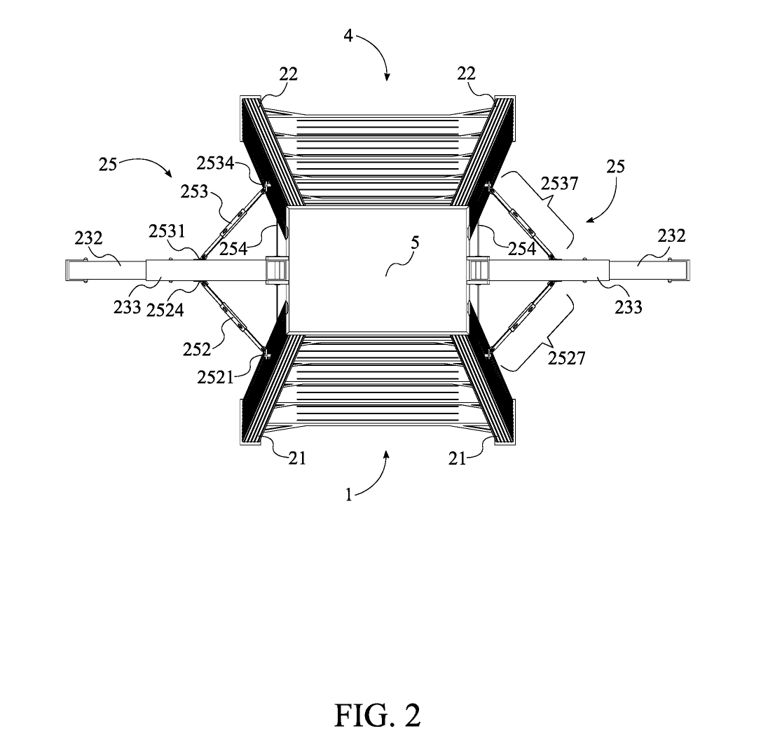

In reference to FIG. 1 and FIG. 2, the present invention, the safety step ladder, is a ladder that is designed with supplementary support legs which augment the ladder's stability. The present invention is designed to function as a traditional A-Frame ladder that has a pair of collapsible support legs that extend from its sides. These support legs prevent the ladder from toppling over. The present invention comprises a front set of rungs 1, a left support mechanism 2, and a right support mechanism 3. To that end, the left support mechanism 2 and the right support mechanism 3 function as the two sides of the ladder between which the rungs are suspended. The left support mechanism 2 and the right support mechanism 3 each comprise a ladder rail 21, a bracing leg 22, an outrigger 23, a terminal junction 24, and a spreader assembly 25. The ladder rail 21 is rigid a beam. The bracing leg 22 is a rigid beam that function as the rear support leg for the present invention. Finally, the outrigger 23 is a rigid beam that augment the A-frame structure formed by the ladder rails 21 and the support legs. The terminal junction 24 is a joint that connects the ladder rail 21, the bracing leg 22, and the outrigger 23, such that these components are maintained in a configuration that forms an A-frame. The ladder rail 21 is hingedly connected to the terminal junction 24 so that one end of each ladder rail 21 is positioned at the apex of the A-frame formed by the left support mechanism 2 and the right support mechanism 3. Similarly, the bracing leg 22 is hingedly connected to the terminal junction 24. As a result, one end of each bracing leg 22 is positioned at the apex of the A-frame formed by the left support mechanism 2 and the right support mechanism 3. The outrigger 23 is hingedly connected to the terminal junction 24. Consequently, the outrigger 23 is able to pivot in a direction that is perpendicular to the motion of the ladder rail 21 and the bracing leg 22. In the preferred embodiment of the present invention, the left support mechanism 2 and the right support mechanism 3 are made of fiberglass material.

In reference to FIG. 1 and FIG. 2, the spreader assembly 25 is a collection of ladder spreaders that are used to brace the components of the present invention. The ladder rail 21, the bracing leg 22, and the outrigger 23 are collapsibly connected to each other by the spreader assembly 25. Consequently, the spreader assembly 25 assembly is able to guide the motion of the ladder rail 21, the bracing leg 22, and the outrigger 23 between an expanded configuration and a collapsed configuration. Furthermore, the spreader assembly 25 is positioned offset from the terminal junction 24. As a result, the spreader assembly 25 is positioned in a location which facilitates increasing the stability of the present invention when deployed. The spreader assembly 25, is preferably a collection of rigid ladder spreaders that lock the ladder rail 21, the bracing leg 22, and the outrigger 23 in place when the spreader assembly 25 is extended. The front set of rungs 1 is connected between the ladder rail 21 of the left support mechanism 2 and the ladder rail 21 of the right support mechanism 3. Consequently, the front set of rungs 1 become the rungs which bind the left support mechanism 2 to the right support mechanism 3.

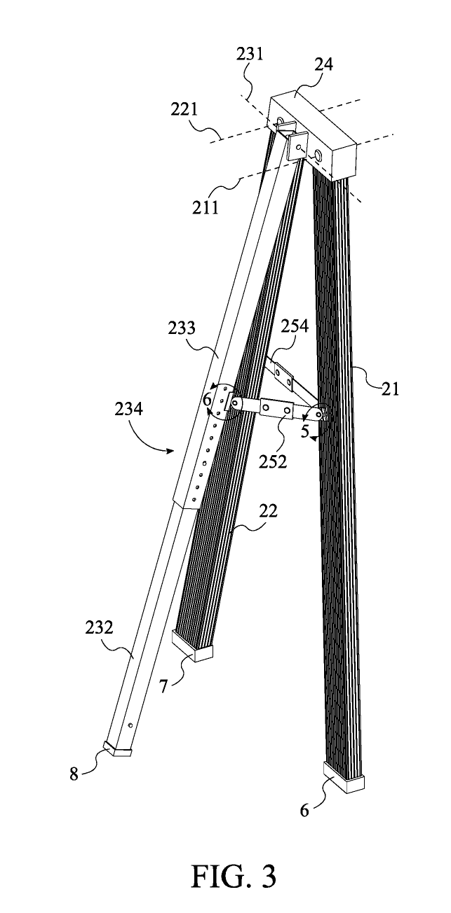

In reference to FIG. 1 and FIG. 3, the ladder rail 21 and the bracing leg 22 are positioned, such that a rotation axis 211 of the hinged connection between the ladder rail 21 and the terminal junction 24 is parallel to a rotation axis 221 of the hinged connection between the bracing leg 22 and the terminal junction 24. Accordingly, the ladder rail 21 and the bracing leg 22 are able to rotate between the expanded configuration and the collapsed configuration. Conversely, the outrigger 23 is positioned, such that a rotation axis 211 of the hinged connection between the ladder rail 21 and the terminal junction 24 is perpendicular to a rotation axis 231 of the hinged connection between the outrigger 23 and the terminal junction 24. As a result, the outrigger 23 is able to pivot away from the ladder rail 21 and bracing leg 22. This pivoting motion enables the outrigger 23 to function as an additional support mechanism for the present invention.

In reference to FIG. 1 and FIG. 2, the present invention further comprises a rear set of rungs 4. The rear set of rungs 4 are connected in between the bracing leg 22 of the left support mechanism 2 and the bracing leg 22 of the right support mechanism 3. Consequently, the rear set of rungs 4 enables the bracing leg 22 of the left support mechanism 2 and the bracing leg 22 of the right support mechanism 3 to act as braces which support the present invention is a desired orientation when deployed. Furthermore, the rear set of rungs 4 fixes the bracing leg 22 of the left support mechanism 2 to the bracing leg 22 of the right support mechanism 3.

In reference to FIG. 1 and FIG. 3, in the preferred embodiment of the present invention, the outrigger 23 is a length-adjustable support leg that can be locked once extended to a desired length. The outrigger 23 comprises an internal member 232, an external sleeve 233, and a locking mechanism 234. The internal member 232 is a rigid beam that is telescopically engaged to the external sleeve 233 so that the internal member 232 can slide into and out of the external sleeve 233. By sliding the internal member 232 into, or out of, the external sleeve 233, a user is able to adjust the length of the outrigger 23. The locking mechanism 234 is operatively integrated into the telescopic engagement between the internal member 232 and the external sleeve 233. As a result, the locking mechanism 234 is able to restrict the telescopic motion of the internal member 232 and external sleeve 233, while engaged. In a first alternative embodiment of the locking mechanism 234, a plurality of holes traverses through the internal member 232 and the external sleeve 233. The user is able to maintain the internal member 232 and external sleeve 233 at a desired length by inserting a set pin into a selected hole from the plurality of holes.

In reference to FIG. 1 and FIG. 2, in the preferred embodiment of the present invention, the spreader assembly 25 comprises a forward spreader 252 and a rearward spreader 253. The forward spreader 252 and the rearward spreader 253 are used to move the outrigger 23 between the expanded and the collapsed configuration. The forward spreader 252 is adjacently and hingedly connected to the outrigger 23 so that one end of the forward spreader 252 is anchored to the outrigger 23. Additionally, the forward spreader 252 is adjacently and hingedly connected to the ladder rail 21, opposite to the outrigger 23. Consequently, the forward spreader 252 is anchored to the ladder rail 21 and extends between the outrigger 23 and the ladder rail 21. The rearward spreader 253 is adjacently and hingedly connected to the outrigger 23. Accordingly, the rearward spreader 253 is anchored to the outrigger 23 at one end. Additionally, the rearward spreader 253 is adjacently and hingedly connected to the bracing leg 22, opposite to the outrigger 23 so that the rearward spreader 253 extends between the outrigger 23 and the bracing leg 22.

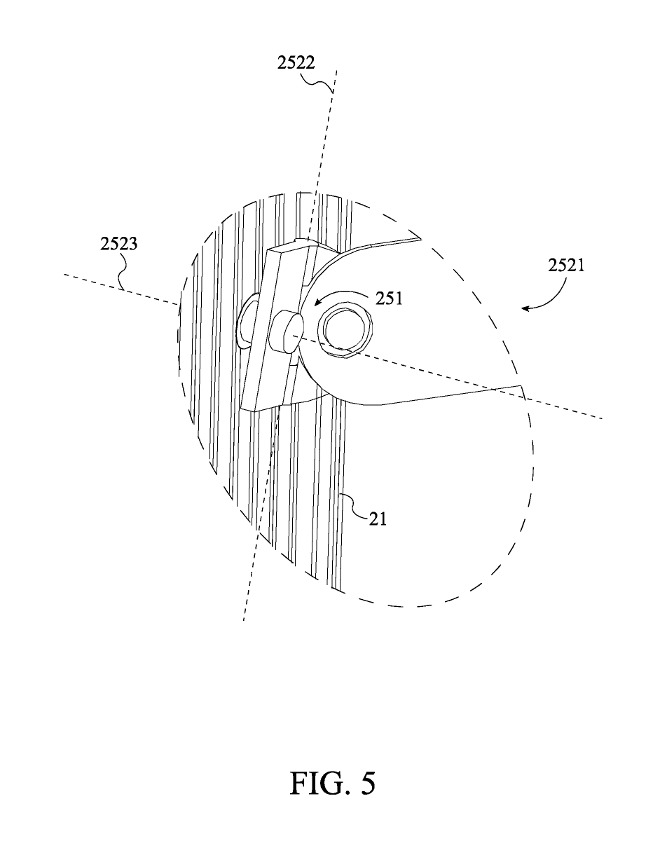

In reference to FIG. 2, FIG. 3, and FIG. 5, in the preferred embodiment of the present invention, the hinged connection 2521 between the forward spreader 252 and the ladder rail 21 is a universal hinge. The universal hinge is a hinge mechanism that enables movement along multiple degrees of freedom. The universal hinge comprises a first rotation axis 2522 and a second rotation axis 2523. The first rotation axis 2522 and the second rotation axis 2523 being offset from each other along the universal hinge. As a result, the first rotation axis 2522 and the second rotation axis 2523 are positioned to facilitate repositioning the forward spreader 252. The first rotation axis 2522 is positioned parallel to the ladder rail 21. Consequently, the first rotation axis 2522 enables the forward spreader 252 to pivot about the first rotation axis 2522. The second rotation axis 2523 is positioned perpendicular to the first rotation axis 2522 so that the forward spreader 252 is able to pivot about the second rotation axis 2523, thereby gaining an additional degree of freedom.

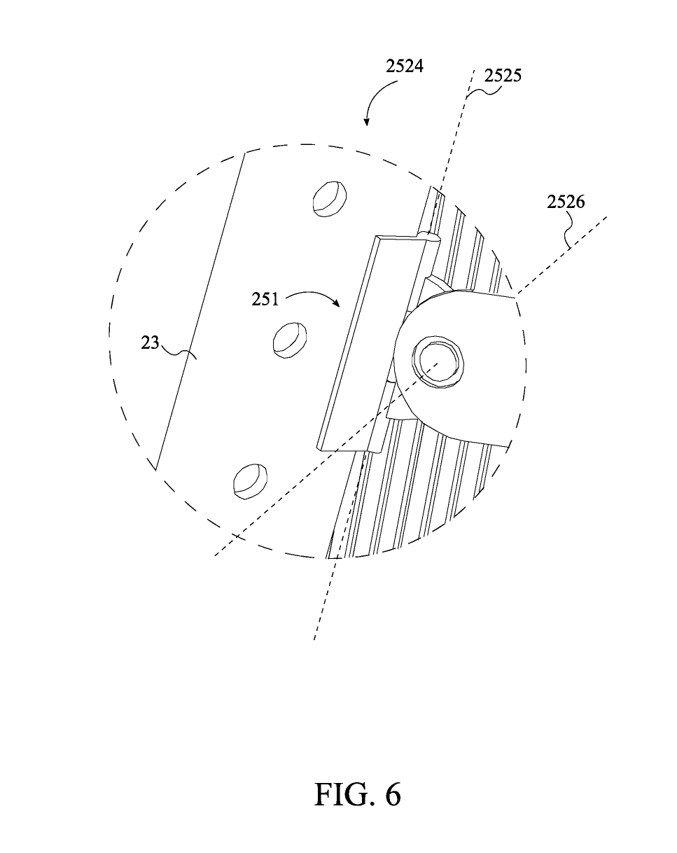

In reference to FIG. 2, FIG. 3, and FIG. 6, in the preferred embodiment of the present invention, the hinged connection 2524 between the forward spreader 252 and the outrigger 23 is a universal hinge. The universal hinge is a hinge mechanism that enables movement along multiple degrees of freedom. The universal hinge comprises a third rotation axis 2525 and a fourth rotation axis 2526. The third rotation axis 2525 and the fourth rotation axis 2526 being offset from each other along the universal hinge. As a result, the third rotation axis 2525 and the fourth rotation axis 2526 are positioned to facilitate repositioning the forward spreader 252. The third rotation axis 2525 is positioned parallel to the outrigger 23. Consequently, the third rotation axis 2525 enables the forward spreader 252 to pivot about the third rotation axis 2525. The fourth rotation axis 2526 is positioned perpendicular to the third rotation axis 2525 so that the forward spreader 252 is able to pivot about the fourth rotation axis 2526, thereby gaining an additional degree of freedom.

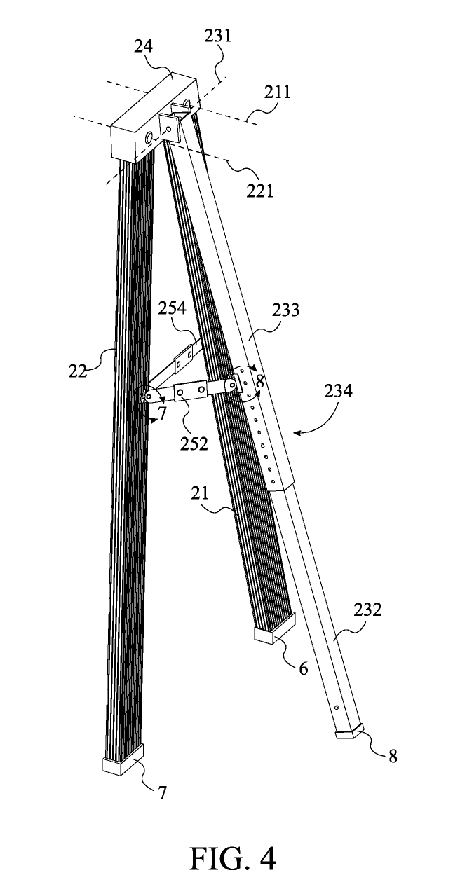

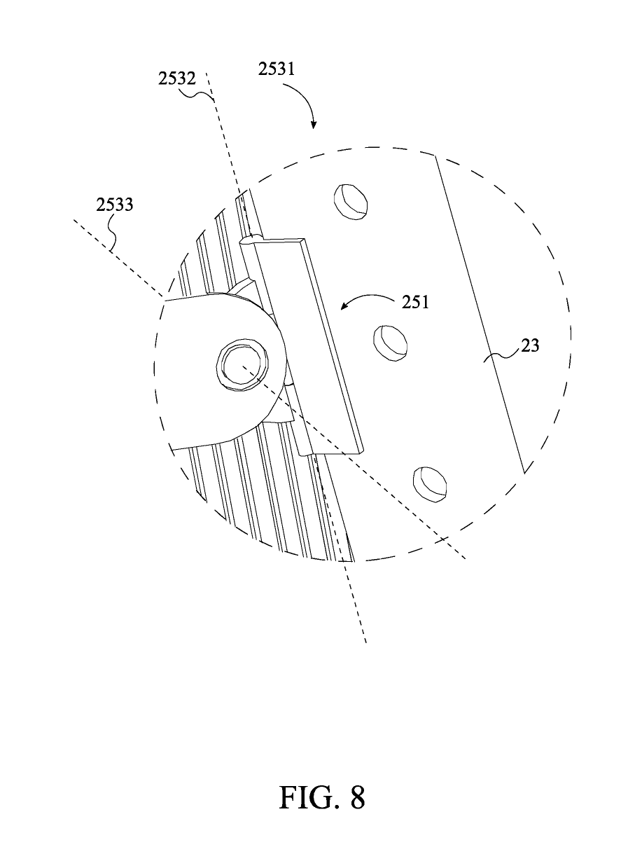

In reference to FIG. 2, FIG. 4, and FIG. 8, in the preferred embodiment of the present invention, the hinged connection 2531 between the rearward spreader 253 and the outrigger 23 is a universal hinge. The universal hinge is a hinge mechanism that enables movement along multiple degrees of freedom. The universal hinge comprises a fifth rotation axis 2532 and a sixth rotation axis 2533. The fifth rotation axis 2532 and the sixth rotation axis 2533 being offset from each other along the universal hinge. As a result, the fifth rotation axis 2532 and the sixth rotation axis 2533 are positioned to facilitate repositioning the rearward spreader 253. The fifth rotation axis 2532 is positioned parallel to the outrigger 23. Consequently, the fifth rotation axis 2532 enables the rearward spreader 253 to pivot about the fifth rotation axis 2532. The sixth rotation axis 2533 is positioned perpendicular to the fifth rotation axis 2532 so that the rearward spreader 253 is able to pivot about the sixth rotation axis 2533, thereby gaining an additional degree of freedom.

In reference to FIG. 2, FIG. 4, and FIG. 8, in the preferred embodiment of the present invention, the hinged connection 2534 between the rearward spreader 253 and the bracing leg 22 is a universal hinge. The universal hinge is a hinge mechanism that enables movement along multiple degrees of freedom. The universal hinge comprises a seventh rotation axis 2535 and an eighth rotation axis 2536. The seventh rotation axis 2535 and the eighth rotation axis 2536 being offset from each other along the universal hinge. As a result, the seventh rotation axis 2535 and the eighth rotation axis 2536 are positioned to facilitate repositioning the rearward spreader 253. The seventh rotation axis 2535 is positioned parallel to the bracing leg 22. Consequently, the seventh rotation axis 2535 enables the rearward spreader 253 to pivot about the seventh rotation axis 2535.

The eighth rotation axis 2536 is positioned perpendicular to the seventh rotation axis 2535 so that the rearward spreader 253 is able to pivot about the eighth rotation axis 2536, thereby gaining an additional degree of freedom.

In reference to FIG. 1 and FIG. 2, in the preferred embodiment of the present invention, an extended length 2527 of the forward spreader 252 and an extended length 2537 of the rearward spreader 253 are equal to each other. Accordingly, the outrigger 23 is maintained in a position that increases the overall stability of the present invention.

In the preferred embodiment of the present invention, the spreader assembly 25 further comprises a cross spreader 254 that is used to move the ladder rail 21 and the bracing leg 22 between the expanded and the collapsed configuration. The ladder rail 21 is adjacently and hingedly connected to the cross spreader 254 so that the cross spreader 254 can pivot as the ladder rail 21 is moved. The bracing leg 22 is adjacently connected to the cross spreader 254, opposite to the ladder rail 21. As a result, the cross spreader 254 is able to guide the separation between the ladder rail 21 and the bracing leg 22 while the present invention is moving from the collapse configuration to the expanded configuration and vice versa

In reference to FIG. 1, the preferred embodiment of the present invention further comprises a ladder top cap 5. The ladder top cap 5 is used as a junction for the left support mechanism 2 and the right support mechanism 3. As such, the terminal junction 24 of the left support mechanism 2 is integrated into the ladder top cap 5. As a result, the ladder top cap 5 forms the apex of the left support mechanism 2. Similarly, the terminal junction 24 of the right support mechanism 3 is integrated into the ladder top cap 5. Consequently, the ladder top cap 5 forms the apex of the right support mechanism 3. The terminal junction 24 of the left support mechanism 2 and the terminal junction 24 of the right support mechanism 3 are positioned opposite to each other across the ladder top cap 5. Accordingly, the ladder top cap 5 works in conjunction with the front set of rungs 1 and the rear set of rungs 4 to connect the left support mechanism 2 to the right support mechanism 3.

In reference to FIG. 1, the preferred embodiment of the present invention further comprises a non-slip rail pad 6, a non-slip leg pad 7, and a non-slip outrigger pad 8, which are all made of high friction material. The non-slip rail pad 6 is adjacently connected to the ladder rail 21, opposite to the terminal junction 24, so that the ladder rail 21 is prevented from sliding across a surface on which it rests. Similarly, the non-slip leg pad 7 is adjacently connected to the bracing leg 22, opposite to the terminal junction 24. As a result, the bracing leg 22 is prevented from sliding while the present invention is deployed. The non-slip outrigger pad 8 is pivotably and adjacently connected to the outrigger 23, opposite to the terminal junction 24. Consequently, the non-slip outrigger pad 8 enables the outrigger 23 to rest on uneven surfaces without slipping.

In reference to FIG. 1, the preferred embodiment of the present invention further comprises a plurality of textured surfaces 9 which prevent users from falling off of the rungs while climbing. Each of the plurality of textured surfaces 9 is superimposed onto a corresponding rung from the front set of rungs 1. Accordingly, the textured surface increases the friction of each rung in the front set of rungs 1.

Although the invention has been explained in relation to its preferred embodiment, it is to be understood that many other possible modifications and variations can be made without departing from the spirit and scope of the invention as hereinafter claimed.

What is claimed is:

1. A ladder with supplementary support legs comprises:
a front set of rungs;
a left support mechanism;
a right support mechanism;
the left support mechanism and the right support mechanism each comprise a ladder rail, a bracing leg, an outrigger, a terminal junction, and a spreader assembly;
the ladder rail being hingedly connected to the terminal junction;
the bracing leg being hingedly connected to the terminal junction;
the outrigger being hingedly connected to the terminal junction;
the ladder rail, the bracing leg, and the outrigger being collapsibly mounted to each other by the spreader assembly;
the spreader assembly being positioned offset from the terminal junction, and;
the front set of rungs being connected in between the ladder rail of the left support mechanism and the ladder rail of the right support mechanism.

2. The ladder with supplementary support legs as claimed in claim 1 comprises:
a rotation axis of the hinged connection between the ladder rail and the terminal junction being parallel to a rotation axis of the hinged connection between the bracing leg and the terminal junction.

3. The ladder with supplementary support legs as claimed in claim 1 comprises:
a rotation axis of the hinged connection between the ladder rail and the terminal junction being perpendicular to a rotation axis of the hinged connection between the outrigger and the terminal junction.

4. The ladder with supplementary support legs as claimed in claim 1 comprises:
a rear set of rungs, and;
the rear set of rungs being connected in between the bracing leg of the left support mechanism and the bracing leg of the right support mechanism.

5. The ladder with supplementary support legs as claimed in claim 1 comprises:
the outrigger comprises an internal member, an external sleeve, and a locking mechanism;
the internal member being telescopically engaged to the external sleeve, and;
the locking mechanism being operatively integrated into the telescopic engagement between the internal member and the external sleeve.

6. The ladder with supplementary support legs as claimed in claim 1 comprises:
the spreader assembly comprises a forward spreader and a rearward spreader;
the forward spreader being adjacently and hingedly connected to the outrigger;
the forward spreader being adjacently and hingedly connected to the ladder rail, opposite to the outrigger;
the rearward spreader being adjacently and hingedly connected to the outrigger, and;
the rearward spreader being adjacently and hingedly connected to the bracing leg, opposite to the outrigger.

7. The ladder with supplementary support legs as claimed in claim 6 comprises:
the hinged connection between the forward spreader and the ladder rail being a universal hinge;
the universal hinge comprises a first rotation axis and a second rotation axis;
the first rotation axis and the second rotation axis being offset from each other along the universal hinge;
the first rotation axis being positioned parallel to the ladder rail, and;
the second rotation axis being positioned perpendicular to the first rotation axis.

8. The ladder with supplementary support legs as claimed in claim 6 comprises:
the hinged connection between the forward spreader and the outrigger being a universal hinge;
the universal hinge comprises a third rotation axis and a fourth rotation axis;
the third rotation axis and the fourth rotation axis being offset from each other along the universal hinge;
the third rotation axis being positioned parallel to the outrigger, and;
the fourth rotation axis being positioned perpendicular to the third rotation axis.

9. The ladder with supplementary support legs as claimed in claim 6 comprises:
the hinged connection between the rearward spreader and the outrigger being a universal hinge;
the universal hinge comprises a fifth rotation axis and a sixth rotation axis;
the fifth rotation axis and the sixth rotation axis being offset from each other along the universal hinge;
the fifth rotation axis being positioned parallel to the outrigger, and;
the sixth rotation axis being positioned perpendicular to the fifth rotation axis.

10. The ladder with supplementary support legs as claimed in claim 6 comprises:
the hinged connection between the rearward spreader and the bracing leg being a universal hinge;
the universal hinge comprises a seventh rotation axis and an eighth rotation axis;
the seventh rotation axis and the eighth rotation axis being offset from each other along the universal hinge;
the seventh rotation axis being positioned parallel to the bracing leg, and;
the eighth rotation axis being positioned perpendicular to the seventh rotation axis.

11. The ladder with supplementary support legs as claimed in claim 6 comprises:
an extended length of the forward spreader and an extended length of the rearward spreader being equal to each other.

12. The ladder with supplementary support legs as claimed in claim 1 comprises:
the spreader assembly comprises a cross spreader;
the ladder rail being adjacently and hingedly connected to the cross spreader, and;
the bracing leg being adjacently and hingedly connected to the cross spreader, opposite to the ladder rail.

13. The ladder with supplementary support legs as claimed in claim 1 comprises:
a ladder top cap;
the terminal junction of the left support mechanism being integrated into the ladder top cap;
the terminal junction of the right support mechanism being integrated into the ladder top cap, and;
the terminal junction of the left support mechanism and the terminal junction of the right support mechanism being positioned opposite to each other across the ladder top cap.

14. The ladder with supplementary support legs as claimed in claim 1 comprises:
a non-slip rail pad, and;
the non-slip rail pad being adjacently connected to the ladder rail, opposite to the terminal junction.

15. The ladder with supplementary support legs as claimed in claim 1 comprises:
a non-slip leg pad, and;
the non-slip leg pad being adjacently connected to the bracing leg, opposite to the terminal junction.

16. The ladder with supplementary support legs as claimed in claim 1 comprises:
a non-slip outrigger pad, and;
the non-slip outrigger pad being pivotably and adjacently connected to the outrigger, opposite to the terminal junction.

17. The ladder with supplementary support legs as claimed in claim 1 comprises:
a plurality of textured surfaces, and;
each of the plurality of textured surfaces being superimposed onto a corresponding rung from the front set of rungs.

18. The ladder with supplementary support legs as claimed in claim 1, wherein the left support mechanism and the right support mechanism are made of a fiberglass material.
